(19) United States
(12) Patent Application Publication
(10) Pub. No.: US 2009/0073354 A1
(43) Pub. Date: Mar. 19, 2009

(54) Color Filter and Liquid Crystal Display Comprising Same

(75) Inventors: Ya-Ling Hsu, Hsinchu (TW); Chun-Chieh Wang, Hsinchu (TW); Chen-Hsien Liao, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/102,229

(22) Filed: Apr. 14, 2008

(30) Foreign Application Priority Data
Sep. 14, 2007 (TW) 96134408

(51) Int. Cl. G02F 1/1335; G02B 5/23

(52) U.S. Cl. 349/106; 359/892; 359/891

(57) ABSTRACT

A color filter and an LCD including the color filter are provided. The color filter includes a substrate with a first side and a second side opposite to said first side, a blue color resist formed on the first side, and a transparent conductive layer at least locally formed on the blue color resist that defines a blue light transmissive area. The first blue chromaticity coordinate of the color filter (By₁) is less than or equal to about 0.08, while a standard C light source is disposed adjacent to the second side and the light with a wavelength ranging from about 380 to about 780 nm from the standard C light source passing through the blue color resist and the transparent conductive layer. Alternatively, the first blue chromaticity coordinate (By₁), which is less than or equal to about 0.08, would be calculated based on the measured transmission spectrum of the blue light transmissive area in association with the spectrum of the standard C light source.

### CROSS-REFERENCES TO RELATED APPLICATIONS

This application claims the benefit from the priority of Taiwan Patent Application No. 096134408 filed on Sep. 14, 2007; the disclosures of which are incorporated by reference herein in their entirety.

### BACKGROUND OF THE INVENTION

1. Field of the Invention

The present invention relates to a color filter, and more particularly, relates to a color filter for enhancing the color saturation in a liquid crystal display (LCD).

2. Descriptions of the Related Art

Liquid crystal displays (LCDs) have gradually become the dominant display apparatus for displaying various information. As a result, it is important to address the various components of the display, such as color saturation. An LCD displays a color image in the following way. Light rays from an internal backlight module or ambient light rays are controlled by a drive integrated circuit (IC) and liquid crystal molecules to form a gray scale image. The light rays, which have been adjusted to a gray scale, transmit through red, green and blue color resists formed on the color filter to generate light rays of the three primary colors (i.e., red, green and blue). Finally, the red, green and blue light rays are mixed by a spatial color mixing method to yield a colorful effect, thus presenting a color image.

For an LCD to display color images with high color saturation and high color reproducibility, red, green and blue color saturations are generally enhanced individually in an LCD screen. According to the chromaticity coordinate system (CIE1931) established by the International Commission on Illumination (CIE) in 1931, enhancing green saturation helps to improve the color saturation. However, the CIE1931 chromaticity coordinate system fails to comply with the human eyes' sensitivity to colors. On the other hand, a chromaticity coordinate system (CIE1976) established by the CIE in 1976 is more compatible with the human eyes' sensitivity to colors. The CIE1976 chromaticity coordinate system enhances the blue color saturation, which improves the color saturation in an LCD, and is compatible with the actual view (i.e., the view of the human eye) of the LCD.

Accordingly, enhancing blue color saturation has gradually become a primary means for improving the color saturation of LCDs. Among the methods commonly used at present to enhance blue color saturation, most of the methods accomplish this by increasing the pigment concentration or thickness of the blue color resist on the color filter. Unfortunately, to increase the pigment concentration of the blue color resist, the concentration of the photosensitive materials will also have to decrease correspondingly, thus resulting in instability when the resist is coated and deactivated during the exposure and development reactions. Consequently, the blue color resist residuals may be left in non-predetermined areas to cause the incorrect color filtering effect in the color filter. Furthermore, an increase to the pigment concentration in the blue color resist also leads to a decrease in the concentration of other additives in the blue color resist, which may cause a poor blue color resist (e.g., degradation of hardness) and even various problems related to the production of the color filter (e.g., color difference or poor uniformity in film thickness), thus lowering the production yield of the color filter. On the other hand, if the thickness of the blue color resist is increased, the transmittance with respect to the blue light will be compromised or problems related to production of the color filter will occur, thus lowering the production yield. Furthermore, it is costly to increase the pigment concentration or increase the thickness of the blue color resist.

Accordingly, because the methods for enhancing blue color saturation in the prior art are all known to have a number of shortcomings, it is highly desirable in the art to provide a color filter capable of enhancing blue color saturation without suffering from the aforesaid problems.

### SUMMARY OF THE INVENTION

It is known from the above description that improvement to the blue color saturation presented by the color filter will allow an LCD to have better color saturation. Accordingly in this invention, the color filter is allowed to present higher blue color saturation by increasing the transmittance of the color filter with respect to blue light. That is, by allowing the thickness of the transparent conductive layer in the color filter to fall within a certain range, the blue light transmittance in the color filter will be higher. Consequently, as more blue light is transmitted through the color filter, a higher blue color saturation will be presented.

One objective of this invention is to provide a color filter. The color filter comprises a substrate having a first side and a second side opposite to the first side, a blue color resist formed on the first side of the substrate, and a transparent conductive layer at least partially formed on the blue color resist and defining a blue light transmissive area. When the substrate is provided with a standard C light source on the second side after transmitting through the blue color resist and the transparent conductive layer, light with a wavelength ranging from about 380 nm to about 780 nm is adapted to present a first blue chromaticity coordinate (By₁) of an XYZ color system which has a value less than or equal to about 0.08. Alternatively, the first blue chromaticity coordinate (By₁), which is less than or equal to about 0.08, can be calculated based on a measured transmission spectrum of the blue light transmissive area in association with the spectrum of the standard C light source.

Another objective of this invention is to provide a liquid crystal display comprising a color filter and a light source. The color filter comprises a substrate having a first side and a second side opposite to the first side, a blue color resist formed on the first side of the substrate, and a transparent conductive layer at least partially formed on the blue color resist and defining a blue light transmissive area. The light source is disposed on the second side of the substrate and is configured to provide light with a wavelength ranging from about 380 to about 780 nm to the blue color resist and the transparent conductive layer. The blue light transmissive area is adapted to present a first blue chromaticity coordinate (By₁) of an XYZ color system which has a value less than or equal to about 0.08 after the light emitted from the light source travels through the blue color resist and the transparent conductive layer. Alternatively, the first blue chromaticity coordinate (By₁) of the XYZ color system, which is less than or equal to about 0.08, can be calculated based on a measured transmission spectrum of the blue light transmissive area in association with the spectrum of the standard C light source.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a partial schematic cross-sectional view of a color filter of this invention; and

FIG. 2 is a graph of a thickness versus a blue light transmittance of a transparent conductive layer.

### DESCRIPTION OF THE PREFERRED EMBODIMENT

In a color filter, the light transmittance of a transparent conductive layer is generally affected by the thickness of the transparent conductive layer. That is, when the transparent conductive layer is relatively thin, the transparent conductive layer will exhibit a relatively high transmittance with respect to the short-wavelength light. As known from convention, blue light has a shorter wavelength relative to the light of other colors. Accordingly, this invention is intended to increase the blue light transmittance and also the blue color purity of the color filter by reducing the thickness of the transparent conductive layer so that the light transmitted through the color filter presents high blue color saturation. Hereinafter, the primary technical features of this invention will be described with reference to an embodiment thereof, in which elements unrelated to this invention are omitted from description. However, other embodiments may occur to those skilled in the art upon reviewing the technical disclosure herein.

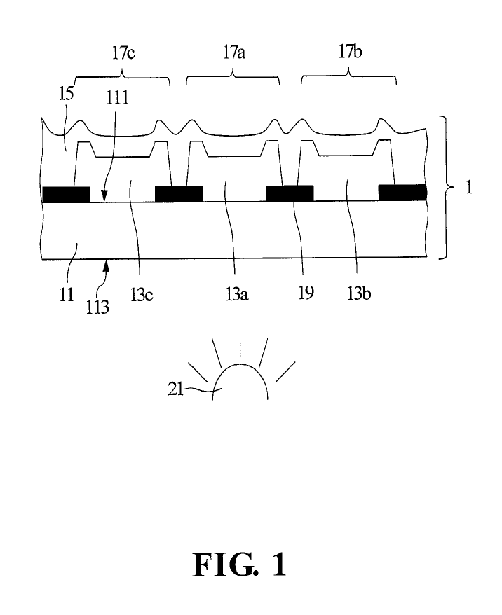

As shown in FIG. 1, the color filter 1 comprises a substrate 11, a blue color resist 13a, a red color resist 13b, a green color resist 13c and a transparent conductive layer 15. The substrate 11 has a first side 111 and a second side 113 opposite to the first side 111. The red color resist 13b, the green color resist 13c and the blue color resist 13a are formed on the first side 111 of the substrate 11. Generally, the thickness of the red color resist 13b and the green color resist 13c, as well as the relative locations of the blue color resist 13a, the red color resist 13b and the green color resist 13c are subject to no limitation. The color filter 1 also comprises a black matrix (BM) 19 distributed between any two of the blue color resist 13a, the red color resist 13b and the green color resist 13c to shield unnecessary light rays.

The transparent conductive layer 15 is typically an indium tin oxide (ITO) layer. For convenience of description, an ITO layer is adopted for the transparent conductive layer 15 in the description of this embodiment. In other implementations, those skilled in the art may adopt other alternative materials. The transparent conductive layer 15 covers at least the red color resist 13b, the green color resist 13c and the blue color resist 13a. In general, the transparent conductive layer 15 covers the resists 13a, 13b and 13c continuously. Additionally, a red light transmissive area 17b, a green light transmissive area 17c and a blue light transmissive area 17a are defined above the transparent conductive layer 15 corresponding to the resists 13b, 13c and 13a respectively. When a light travels through the color filter 1 from the second side 113 of the substrate 11, a red light, a green light and a blue light will be obtained in the red light transmissive area 17b, the green light transmissive area 17c and the blue light transmissive area 17a respectively.

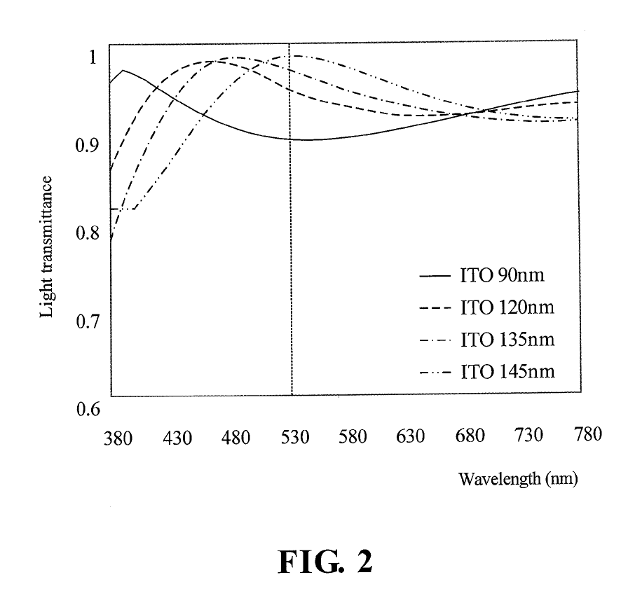

FIG. 2 illustrates a light transmission spectrum of the transparent conductive layer 15 (i.e., an ITO layer) with a thickness of 90 nm, 120 nm, 135 nm and 145 nm respectively. It can be seen from this figure that when having a thickness ranging from about 90 nm to about 135 nm, the transparent conductive layer 15 exhibits a high light transmittance with respect to a short-wavelength visible light spectrum (i.e., a wavelength ranging from about 380 nm to about 530 nm). In this embodiment, when a light transmits through the transparent conductive layer 15, the transparent conductive layer 15 defines a high light transmittance ranging from about 50% to about 99%. If there is a thickness between 90 nm and 135 nm, the transparent conductive layer 15 in the blue light transmissive area 17a will exhibit a maximum blue light transmittance and also a high blue color purity, thus resulting in a high blue color saturation in the color filter 1. It should be noted that the above thickness values of the transparent conductive layer 15 are only intended to illustrate rather than to limit this invention, and the thickness value of the transparent conductive layer 15 may vary in other embodiments of the color filter.

Furthermore, in addition to the thickness of the transparent conductive layer 15, the blue light saturation is also associated with the properties of the blue color resist 13a such as light transmittance, concentration and thickness.

Table 1 below illustrates the relationships between the thickness of the transparent conductive layer 15 (i.e., an ITO layer) and a second blue chromaticity coordinate (By₂) of the blue color resist 13a when the color filter 1 exhibits a first blue chromaticity coordinate (By₁) under the illumination from a standard C light source. In particular, a light source 21, which is a standard C light source, is disposed on the second side 113 of the substrate 11. When a light with a wavelength ranging from about 380 nm to about 780 nm emitted by the light source 21 transmits through the blue color resist 13a and the transparent conductive layer 15, the color filter 1 will exhibit a first blue chromaticity coordinate (By₁) of an XYZ color system, which is less than or equal to about 0.08, and preferably, less than or equal to about 0.077. Alternatively, the first blue chromaticity coordinate (By₁), which is less than or equal to about 0.08 and preferably less than or equal to about 0.077, can be calculated based on a measured transmission spectrum of the blue color resist 13a and the transparent conductive layer 15 in association with the spectrum of the standard C light source. On the other hand, light transmitted through only the blue color resist 13a is adapted to present a second blue chromaticity coordinate (By₂) of the XYZ color system, which ranges from about 0.065 to about 0.085 and preferably from about 0.07 to about 0.08. Alternatively, the second blue chromaticity coordinate (By₂), which ranges from about 0.065 to about 0.085 and preferably from about 0.07 to about 0.08, can be calculated based on a measured transmission spectrum of the blue color resist 13a in association with the spectrum of the standard C light source.

TABLE 1

| | | Thickness of | | |
|---|---|---|---|---|
| | | the ITO | | Concentration or film thickness |
| Group | By1 | layer (nm) | By2 | of the blue color resist |
| Group 1 | 0.076 | 135 | 0.075 | — |
| Group 2 | 0.076 | 120 | 0.077 | 97.35 (relative to group 1) |
| Group 3 | 0.076 | 90 | 0.078 | 94.74 (relative to group 1) |

Because the concentration or film thickness of the blue color resist 13a is positively correlated with the second blue chromaticity coordinate (By₂) exhibited by the light transmitted through the blue color resist 13a, a blue color resist with a lower concentration (i.e., a less blue resist) in Group 1 will exhibit a larger second blue chromaticity coordinate (By₂). Consequently, a different thickness of an ITO layer can be used in conjunction with a different second blue chromaticity coordinate (By₂) of the blue color resist, so that the light transmitted through the blue color resist 13a and the transparent conductive layer 15 will achieve the same first blue chromaticity coordinate (By₁).

Thus, the desired first blue chromaticity coordinate (By₁) can also be achieved in the color filter 1 by providing an appropriate concentration of the blue color resist. A thin transparent conductive layer 15 may be used in conjunction with the appropriate concentration of the blue color resist 13a to achieve the desired first blue chromaticity coordinate (By₁) in the color filter 1, thereby reducing cost and the difficulty in manufacturing the color filter 1.

Color filters 1 with an ITO layer of a different thickness are applied in an LCD respectively. Each of the color filters 1 has a first blue chromaticity coordinate (By₁) which is less than or equal to about 0.08, and preferably, less than or equal to about 0.077. The LCD comprises one of the color filters 1 and a light source 21, which may be a light source of a common backlight module. As shown in Table 2, it has been found that when using each of the groups, the LCD all exhibits a third blue chromaticity coordinate (By₃) less than or equal to about 0.06.

TABLE 2

| Group | Thickness of the ITO layer (nm) | By₃ |
|---|---|---|
| Group 1 | 90 | 0.056 |
| Group 2 | 120 | 0.057 |
| Group 3 | 135 | 0.059 |

In summary, by controlling the thickness of the transparent conductive layer, this invention can be effectively applied to a color filter to enhance the blue color saturation thereof. When used in conjunction with an appropriate blue color resist concentration, this invention will not only enhance the blue color saturation effectively, but also reduce the cost and difficulty in manufacturing the color filter without the need to modify the composition and consequently the physical property of the blue color resist. Therefore, since the color filter of this invention can enhance color saturation of an LCD, the color filter has great industrial applicability.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A color filter, comprising:
a substrate having a first side and a second side opposite to the first side;
a blue color resist formed on the first side of the substrate; and
a transparent conductive layer at least partially formed on the blue color resist and defining a blue light transmissive area,
wherein the blue light transmissive area of the color filter is adapted to present a first blue chromaticity coordinate (B_{y1}) of an XYZ color system to have a value less than or equal to about 0.08.

2. The color filter as claimed in claim 1, wherein the first blue chromaticity coordinate (B_{y1}) is less than or equal to about 0.077.

3. The color filter as claimed in claim 1, wherein the blue light transmissive area is adapted to present a second blue chromaticity coordinate (B_{y2}) of the XYZ color system to have a value ranging from about 0.065 to about 0.085, while a light emitted from a standard C light source travels through the blue color resist.

4. The color filter as claimed in claim 3, wherein the second blue chromaticity coordinate (B_{y2}) ranges from about 0.07 to about 0.08.

5. The color filter as claimed in claim 1, wherein the transparent conductive layer within the blue light transmissive area has a thickness ranging from about 90 to about 135 nm.

6. The color filter as claimed in claim 1, wherein the transparent conductive layer is an indium tin oxide (ITO) layer.

7. The color filter as claimed in claim 1, wherein the blue light transmissive area has a maximum transmittance ranging from about 50% to about 99%.

8. The color filter as claimed in claim 1, further comprising a red color resist and a green color resist separately formed on the first side and defining a red light transmissive area and a green light transmissive area, respectively, wherein the transparent conductive layer covers the red color resist, the blue color resist, and the green color resist continuously.

9. The color filter as claimed in claim 8, further comprising a black matrix (BM) disposed between any two of the red color resist, the blue color resist, and the green color resist.

10. A liquid crystal display, comprising:
a color filter, having:
a substrate having a first side and a second side opposite to the first side;
a blue color resist formed on the first side of the substrate; and
a transparent conductive layer at least partially formed on the blue color resist and defining a blue light transmissive area; and
a light source disposed on the second side of the substrate and configured to provide a blue light with a wavelength ranging from about 380 to about 780 nm to the blue color resist and the transparent conductive layer;
wherein the blue light transmissive area is adapted to presents a first blue chromaticity coordinate (B_{y1}) of an XYZ color system to have a value less than or equal to about 0.08, after a light emitted from a standard C light source travels through the blue color resist and the transparent conductive layer.

11. The liquid crystal display as claimed in claim 10, wherein the first blue chromaticity coordinate (B_{y1}) is less than or equal to about 0.077 under the standard C light source.

12. The liquid crystal display as claimed in claim 10, wherein the blue light transmissive area is adapted to present a second blue chromaticity coordinate (B_{y2}) of an XYZ color system to have a value ranging from about 0.065 to about 0.085, while the light emitted from a standard C light source travels through the blue color resist.

13. The liquid crystal display as claimed in claim 12, wherein the second blue chromaticity coordinate (B_{y2}) ranges from about 0.07 to about 0.08 under the standard C light source.

14. The liquid crystal display as claimed in claim 10, wherein the liquid crystal display presents a third blue chromaticity coordinate (B_{y3}) less than or equal to about 0.06.

15. The liquid crystal display as claimed in claim 10, wherein the thickness of the transparent conductive layer within the blue light transmissive area ranges from about 90 to about 135 nm.

16. The liquid crystal display as claimed in claim 10, wherein the transparent conductive layer is an indium tin oxide (ITO) layer.

17. The liquid crystal display as claimed in claim 10, wherein the blue light transmissive area has a maximum transmittance ranging from about 50% to about 99%.

18. The liquid crystal display as claimed in claim 10, wherein the color filter further comprises a red color resist and a green color resist separately formed on the first side and defining a red light transmissive area and a green light transmissive area respectively, wherein the transparent conductive layer covers the red color resist, the blue color resist, and the green color resist continuously.

19. The liquid crystal display as claimed in claim 18, wherein the color filter further comprises a black matrix (BM) disposed between any two of the red color resist, the blue color resist, and the green color resist.
